(19) United States
(12) Patent Application Publication
(10) Pub. No.: US 2022/0259819 A1
(43) Pub. Date: Aug. 18, 2022

(54) OPERATOR'S CABIN HAVING A PROTECTIVE GRID

(71) Applicant: Liebherr-France SAS, Colmar Cedex (FR)

(72) Inventors: Fabrice Thal, Ettendorf (FR); Aurélien Sabaty-Cugnetti, Hoenheim (FR); Jérome Disser, Bischwihr (FR)

(21) Appl. No.: 17/669,848

(22) Filed: Feb. 11, 2022

(30) Foreign Application Priority Data
Feb. 12, 2021 (DE) 10 2021 103 321.7

(51) Int. Cl. E02F 9/16; B62D 33/06; B60R 21/11

(52) U.S. Cl. CPC E02F 9/163; B60R 21/11; B62D 33/0617

(57) ABSTRACT

The invention relates to an operator's cabin of a work machine, in particular of an earth-moving machine, comprising: a housing structure that surrounds a workplace for an operator of the work machine, a front windshield at a front side of the operator's cabin, a front grid that is positioned in its protective position in front of the front windshield, and a roof grid that is positioned in its protective position above a roof section of the operator's cabin. The operator's cabin is characterized in that the front grid and the roof grid can be moved out of their respective protective positions by a rotary movement and/or a translatory movement.

### BACKGROUND OF THE INVENTION

The present invention relates to an operator's cabin having a protective grid, in particular for operator's cabins for work machines such as earth-moving machine or the like.

It is necessary in a large number of work machines to additionally reinforce the operator's cabin with protective grids so that the safety of an operator sitting in the operator's cabin is also ensured to the best possible extent in the event of an impact of falling objects that have been hurled up or of any other accident. It can in particular occur under adverse conditions of use that larger rocks or the like fall down so that a danger to the operator can arise.

It is customary in the prior art for this reason to arrange protective grids in front of the front windshield and in the roof region of an operator's cabin that ensure additional protection for the operator in the operator's cabin in the aforesaid case.

The protective grids at the front side and in the roof region are disadvantageous in some situations, however, since the front grid arranged in front of the front windshield, for example, obstructs the view of the operator on the actuation of the work machine.

It is therefore in particular customary that the front grid is dismantled for work that takes place in a non-dangerous environment and requires good visibility. The roof grid is here as a rule also designed as dismantlable since it unnecessarily increases the structure height on a transport of the work machine and unnecessarily complicates a loading of the work machine.

It is problematic with a dismantling or fitting of a protective grid that considerable resources are always required in this respect. The change in the protective grid configuration thus typically also requires a crane or a winch by which the at least one o protective grid can be raised from the operator's cabin or guided toward it. In addition, it represents a time-consuming and dangerous task since it has to be carried out at the outer side of the operator's cabin at a height of a plurality of meters. Smaller collisions with the operator's cabin or with components attached thereto also frequently occur on the attachment or removal of protective grids so that the desired change of a protective grid configuration brings about a large number of disadvantages. The removed grids thus additionally have to be stored at a location separate from the work machine so that the grids first have to be collected for a desired reconfiguration.

### SUMMARY OF THE INVENTION

It is the aim of the present invention to overcome the disadvantages listed above and to provide an operator's cabin improved in this respect and provided with at least one protective grid.

This is done using an operator's cabin of a work machine that has all the features herein. Further advantageous configurations here are included in the explanation in the description.

An operator's cabin is accordingly provided for a work machine, in particular for an earth-moving machine, that comprises a housing structure that surrounds a first workplace for an operator, a front windshield at a front side of the operator's cabin, a front grid that is positioned in its protective position in front of the front windshield, and a roof grid that can be optionally provided and that is positioned above a roof section of the operator's cabin in its protective position, wherein the front grid and/or the roof grid can be brought out of its/their respective protective positions by a rotary and/or translatory movement and nevertheless remains/remain connected to the operator's cabin in so doing.

In accordance with the invention, an operator's cabin is possible that is provided with a roof grid and a front grid that can both be moved out of their respective protective positions. The loading height of the operator's cabin or of the work machine connected thereto can thereby be reduced, for example, since the roof grid can also be conveyed out of its protective position.

The grid or grids remains/remain connected to the operator's cabin here, with it being executed via an articulated connection of a grid to a rotary axle, for example via a hinge-like, one-dimensional or multi-dimensional connection, via a rail connection, or via a similar connection known to the skilled person, for example a rotary joint, or similar, that permits a relative movement of the two connection partners with respect to one another.

Provision can be made in accordance with an advantageous configuration of the invention that the front grid and the protective grid have a substantially similar structure side contour or even a similar structural design that enables a stacking of the two grids on top of one another, that is they are stackable with respect to one another. This produces various advantages in the moving of the protective grid or grids from an associated protective position. Provision can inter alia be made in this respect that the plurality of protective grids at the operator's cabin have identical or almost identical dimensions in their widths so that protective grids stacked on top of one another effectively use the available space. Stackable in the sense of the invention means that the two grids have a side contour that is similar to a high degree and that enables a space-saving placing of the two grids on top of one another.

Provision can also be made that the grids are identical, with the articulated connection section being able to differ at a rotary axle here.

Provision can be made in accordance with a further modification of the present invention that the front grid and the roof grid are pivotable out of their respective protective positions via a common rotary axle so that the grid pivoted out of its protective position lies alongside the grid remaining in its protective position at its side remote from the operator's cabin.

Provision can be made alternatively or additionally to this that the moving of the one grid to the side of the other grid remote from the operator's cabin takes place via a rail system or slide system in which the movement is a curved movement adapted to the contour of the operator's cabin.

Provision can be made in accordance with a further modification of the invention that the front grid can be moved by rotation about a rotary axle extending in the width direction of the operator's cabin and by a translatory movement into a position in which the front grid can be placed at the roof grid located in its protective position at its side remote from the operator's cabin, with the front grid located in its protective position preferably being adapted to first undergo a translatory movement and subsequently lies alongside a side of the roof grid remote from the operator's cabin by a rotary movement or is adapted to first undergo a rotary movement and subsequently lies alongside the side of the roof grid remote from the operator's cabin by a translatory movement.

Provision can furthermore also be made that first a rotation of the front grid, a subsequent displacement, that is translation, and finally another rotation are provided that result in lying alongside the upper side of the roof grid arranged in the protective position.

Provision is preferably made that the front grid that is moved out of its protective position and that is arranged at the side of the roof grid arranged at the roof section remote from the operator's cabin is movable together with the roof grid by means of a common rotary movement and/or a common translatory movement away from the roof section toward a rear, left or right side of the cabin.

Provision can be made in this respect that the roof grid located in its protective position is movable together with the front grid arranged thereabove via a rotary axle extending in parallel with the longitudinal direction of the operator's cabin to the left or right side of the operator's cabin, with the grids placed on top of one another preferably being rotated by approximately 250° to 280°, preferably 260° to 270°, from the protective position of the roof grid about the rotary axle extending in parallel with the longitudinal direction of the operator's cabin.

The operator's cabin is accordingly adapted so that the grids (front grid and roof grid) arranged on top of one another at the roof section are pivotable together via a rotary joint connection to the cabin toward one of its side surfaces so that the two grids can be moved from above the roof construction of the operator's cabin toward a side and the total height of the operator's cabin can thus be reduced.

Provision can further be made in accordance with an optional further development of the invention that the roof grid located in its protected position can be moved together with the front grid arranged thereabove by a common rotation about a rotary axle extending in the width direction of the operator's cabin and by a translatory movement into a position in which the two grids are arranged behind the operator's cabin, with the two grids arranged above the roof section preferably first undergoing a translatory movement and subsequently lying alongside the rear side of the operator's cabin oppositely disposed the front side by a rotary movement or the two grids arranged above the roof section first undergoing a rotary movement and subsequently lying alongside the rear side of the operator's cabin oppositely disposed the front side by a translatory movement.

The two protective grids arranged on top of one another on the roof of the operator's cabin can thus be pivoted by a hinge-like connection to the cabin provided in the rear region of the roof toward the read side of said cabin so that the grid surfaces are aligned approximately perpendicular to the horizontal axis or in parallel with the rear side of the operator's cabin. This reception position also permits a reduction of the total height of the operator's cabin.

Provision can furthermore be made that the roof grid located in its protective position can be conveyed together with the front grid arranged thereabove by a common parallelogram linkage into a region arranged behind the operator's cabin. The two grids arranged above one another can thus also be placed on a storage surface provided behind the operator's cabin while maintaining their alignment approximately in parallel with the horizontal. Parallelogram linkages can be provided for this purpose that are correspondingly connected in an articulated manner to the grid or grids and that enable the desired movement of the two grids with respect to the operator's cabin

Provision can furthermore be made in accordance with an optional modification of the invention that the roof grid can be moved by rotation about a rotary axle extending in the width direction of the operator's cabin and by a translatory movement into a position in which the roof grid is placed at the front grid located in its protective position at its side remote from the operator's cabin, with the roof grid located in its protective position preferably first undergoing a translatory movement and subsequently lying alongside a side of the front grid remote from the operator's cabin by a rotary movement or the roof grid located in its protective position first undergoing a rotary movement and subsequently lying alongside the side of the front grid remote from the operator's cabin by a translatory movement.

Provision can furthermore be made in accordance with an advantageous modification of the invention that the roof grid that is moved out of its protective position and that is arranged at the side of the front grid arranged at the front side remote from the operator's cabin is movable together with the front grid away from the front side below the operator's cabin by means of a common rotary movement and/or a common translatory movement.

The front grid located in its protective position together with the roof grid arranged in front of it can thus here be brought by a common rotation about a rotary axle extending in the width direction of the operator's cabin and by a translatory movement into a position in which the two grids are arranged below the operator's cabin, in particular directly below the operator's cabin, with the two grids arranged in front of the front side preferably first undergoing a rotational movement and subsequently being able to be pushed below the operator's cabin by a translatory movement.

In other words, the front grid with the roof grid arranged in front thereof can be folded away to the front and bottom so that a pushing movement in the direction of the operator's cabin can be carried out to push the two grids into a reception space provided beneath the operator's cabin.

Provision can furthermore be made in accordance with the invention that the front grid located in its protective position can be moved together with the roof grid arranged in front of it by a common rotation about a rotary axle extending in the width direction of the operator's cabin into an approximately horizontal alignment and can subsequently be pushed into a cutout arranged beneath the operator's cabin. The rotary axle extending in the width direction of the operator's cabin is advantageously arranged close to or beneath a base region of the operator's cabin.

Provision can be made in accordance with a further optional embodiment of the invention that that the front grid located in its protective position can be folded away downward from the front side of the operator's cabin via a first rotary axle so that it can be pushed into a reception space arranged below the operator's cabin via a subsequent one-dimensional translatory movement and/or the roof grid located in its protective position can be folded over to the rear from the roof section of the operator's cabin via a second rotary axle so that it can be introduced into a reception space arranged behind the operator's cabin via a subsequent one-dimensional translatory movement, with the rotation of a respective grid preferably adopting a range about its rotary axle of 70° to 110°, more preferably 80° to 100°.

The two protective grids (front grid and roof grid) can accordingly also be moved from their respective protective positions into different reception regions. The reception region for the front grid can thus be provided beneath the operator's cabin and the reception region for the roof grid can be provided behind the operator's cabin.

Provision can furthermore be made in accordance with a further development of the invention that the movement of the front grid and/or of the roof grid takes place by a drive that is preferably a hydraulic and/or an electric motor drive and that serves the movement of the roof grid and/or front grid. Provision can also be made here that the drive can be actuated from the operator's cabin.

The invention further relates to a work machine, in particular to an earth-moving machine, having an operator's cabin in accordance with the description herein.

### BRIEF DESCRIPTION OF THE DRAWINGS

Further advantages, features, and details of the invention will become clear on the basis of the following description of the Figures. There are shown:

FIG. 1: a first embodiment of the present invention;

FIG. 2: a second embodiment of the present invention;

FIG. 3: a third embodiment of the present invention;

FIG. 4: a fourth embodiment of the present invention;

FIG. 5: a configuration change of the front grid from a protective position toward an improved front visibility for the front grid and a conversion from a transport configuration to a protective position for the roof grid;

FIG. 6 front grid or a conversion from a protection position to a transport position for the roof grid;

FIG. 7: a further embodiment of the present invention in which the two grids placed on top of one another can be pushed into a reception space beneath the operator's cabin;

FIG. 8: a further embodiment in which the two grids can be stowed at the rear side of the operator's cabin in parallel with a vertical direction of the operator's cabin;

FIG. 9: a further embodiment for stowing the two grids at a rear side of the operator's cabin;

FIG. 10: a further embodiment for stowing the two grids at a rear side of the operator's cabin;

FIG. 11: a further embodiment for stowing the two grids at different reception locations;

FIG. 12. a further embodiment for an alternative traveling of the front grid to lie alongside the upper side of the roof grid; and

FIG. 13. a further embodiment with a curved travel movement of the front grid to lie alongside the upper side of the roof grid.

### DESCRIPTION OF THE PREFERRED EMBODIMENTS

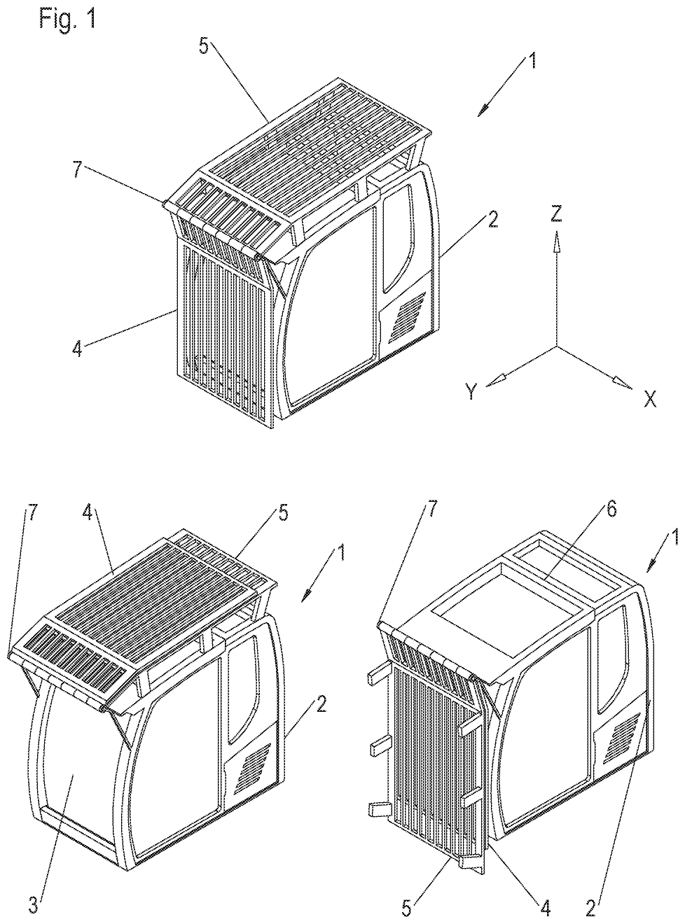

FIG. 1 shows a perspective view of an operator's cabin 1 having a housing structure 2 surrounding a workplace for an operator. This housing structure 2 typically has an access door at its left and/or right side through which the operator can enter into or exit the operator's cabin. At its front side, the housing structure 2 typically has a mount 3 for a front windshield through which the operator can look during a performance of his operating work. When carrying out hazardous work in which rocks or parts of building to be removed can fall down onto the operator's cabin, it is necessary for the increase of the safety of the operator to protect the front side of the operator's cabin with a front grid 4. The same also applies to the roof section 6 of the operator's cabin 2 that can likewise have a cutout for a roof window. It is thus made possible for an operator sitting in the operator's cabin to have a particularly good view upward so that the performance of demanding work activities of the work machine, for example the removal of building parts by means of a demolition excavator, is also made possible. It is thus necessary to also reinforce the roof section with a roof grid 5 so that falling parts also here do not result in a danger to an operator located in the operator's cabin.

As already explained in the introductory part of the present invention, the permanent looking through the front grid 4 is tiring and additionally also reduces the visibility through the front windshield of the operator's cabin 2. It is therefore desirable for the front grid 4 to be removable on a performance of non-dangerous work that does not require the additional protection of the front grid 4. This is made possible in the present case by the articulated connection of the front grid to a rotary axle 7 that extends in the width direction X of the operator's cabin and that enables a pivot movement of the front grid 4 by approximately 270° so that the front grid 4 is placed on the upper side of the roof grid 5, as in the view shown at the bottom left in FIG. 1. An unobstructed view through the front windshield of the operator's cabin 2 is thereby made possible so that work can also be carried out without problem that requires a particularly good view and that is not dangerous.

The roof grid 5 itself is also pivotably arranged at the same rotary axle 7 that permits a pivoting of the front grid 4 onto the upper side of the roof grid 5. If namely a transport of the operator's cabin or of the work machine connected to the operator's cabin takes place, it is of great importance to reduce the total height of the work machine or of the operator's cabin. Care is thus taken on a loading of the work machine or of the operator's cabin that the transport height is minimized and fewer height restrictions have to be observed on the transport of the work machine or of the operator's cabin. The transport mode of the operator's cabin is shown here in the lower right image of FIG. 1. It can be recognized that, starting from the upper representation in which both grids 4, 5 are located in their protective positions, the roof grid 5 has been pivoted via the common rotary axle 7 in front of the front grid 4 located in the protective position. The height (Z direction in the coordinate system of FIG. 1) is thereby reduced so that the transport of the operator's cabin 1 or of the work machine connected thereto can be effected more simply. The change from the front visibility mode that is present in the lower left representation in FIG. 1 toward a transport mode that is shown in the lower right representation in FIG. 1 can accordingly be easily effected by the pivoting round of the grids into the respective position.

Even though it is not shown, the automatic traveling of the grids into the respective positions is also covered by the invention. A drive device can be provided for this purpose that moves the front grid 4 or the roof grid 5 out of their respective protective positions. The provision of a common axle or rotary or pivot axle for the two grids, that is the roof grid 5 and the front grid 4, accordingly enables a particularly simple implementation to achieve the advantages of the present invention.

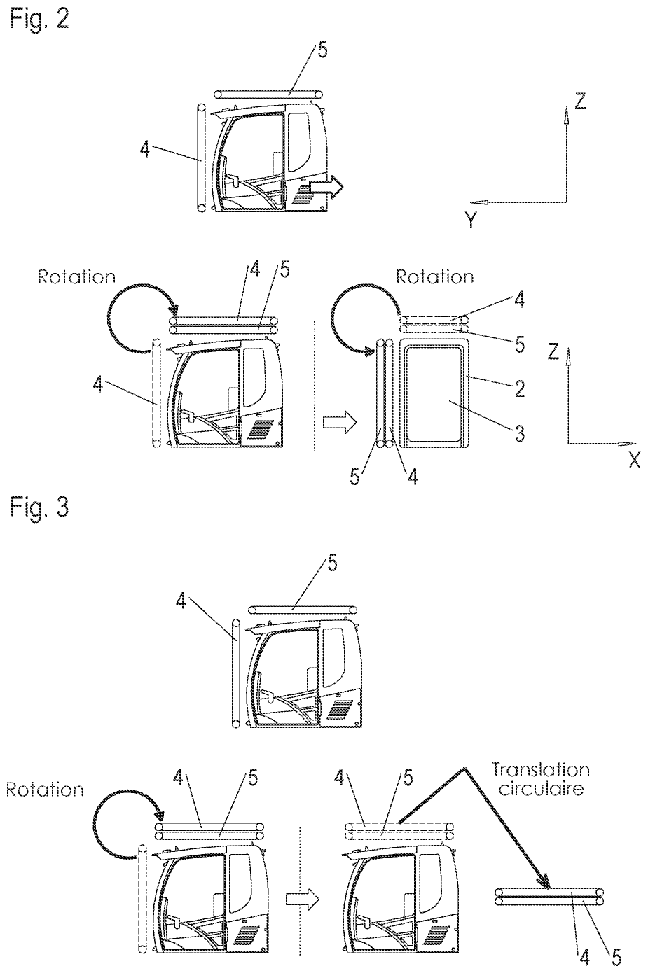

FIG. 2 shows a further embodiment of the present invention in which, after a pivoting of the front grid 4 onto the upper side of the roof grid 5, the grids 4, 5 thus stacked on top of one another can be folded down toward the right side of the operator's cabin 2. The rotary axle of the front grid 4 can thus be established via a connection section to the roof grid 5, with the roof grid 5 itself having a rotary axle that extends in the longitudinal direction Y of the operator's cabin and that is fastened to the operator's cabin 2. It is used to pivot the two grids 4, 5 stacked on top of one another by approximately 270° from the roof section 6 of the operator's cabin 2 down to a right side section of the operator's cabin 2. It is thus also possible to reduce the structural height of the operator's cabin for a transport mode and in so doing to simultaneously improve the front visibility by a folding away of the front grid 4 onto the side of the roof grid 5 remote from the operator's cabin 2.

FIG. 3 shows a further embodiment of the present invention in which the front grid 4 is again pivoted onto the upper side of the roof grid 5 via a rotary axle extending in the width direction of the operator's cabin 2. In the configuration of the two grids 4, 5 stacked on top of one another, a parallelogram deflection now takes place in which the horizontal alignment of the two grids 4, 5 stacked on top of one another is not changed. It is thus possible to place the two grids 4, 5 into a reception location, for example a support surface or the like, provided behind the operator's cabin 2 so that both operating modes, the front visibility mode and the transport mode, can also be achieved here without a final removal of the two grids 4, 5 from the operator's cabin occurring in so doing.

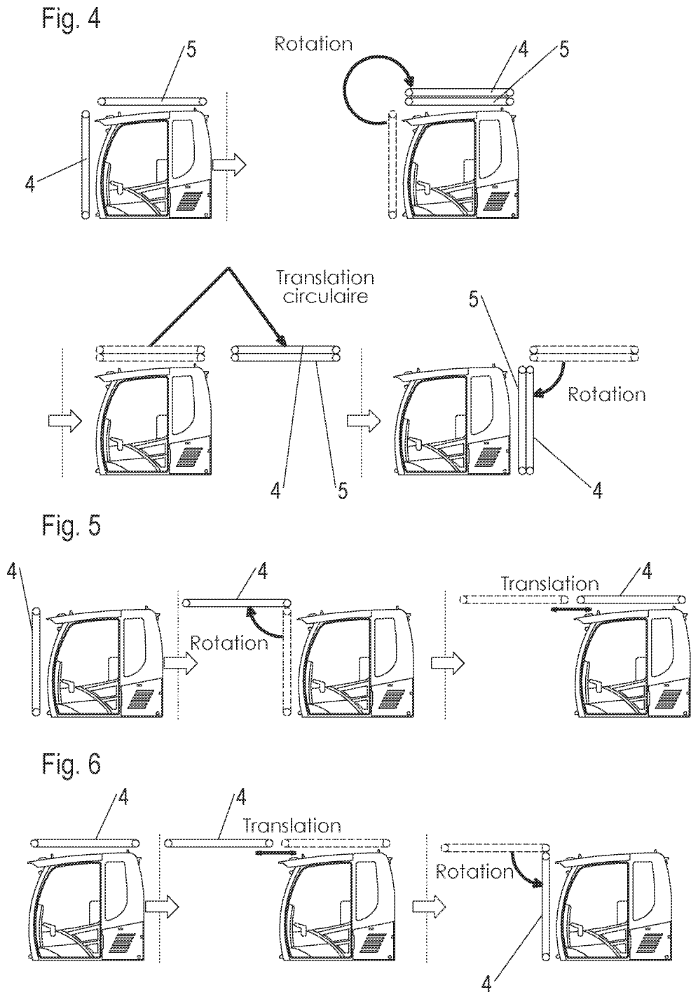

FIG. 4 shows a further embodiment of the present invention in which the front grid 4 is again pivoted onto the upper side of the roof grid 5 via a rotary axle extending in the width direction. A parallelogram linkage of the two grids arranged on top of one another subsequently takes place so that they are now no longer arranged above a roof section of the operator's cabin. A pivoting toward a rear side of the operator's cabin 2 takes place from this state so that the two grids are now arranged approximately in parallel with the previously adopted protective position of the front grid at the rear side of the operator's cabin 2. This represented a particularly space-saving storage possibility of the two grids.

FIGS. 5 and 6 each show only one grid, with, in the event of the front grid 4 and the roof grid 5 being present, the kinematics of movement for both grids 4, 5 being identical. If the grid shown in FIG. 5 is considered as the front grid 4, it is located in its protective position in the left representation of FIG. 5. By a rotation by approximately 90° upward, the front grid 4 is now in an approximately horizontal alignment so that it is movable by a translatory movement or by a pushing into the region above the roof section 6 of the operator's cabin 2. If the grid is the front grid, FIG. 5 therefore shows the change from the protective position of the front grid 4 into the front visibility mode. If, in contrast, the grid shown in FIG. 5 is the roof grid 5, the change from the transport mode into the protective position of the roof grid 5 is shown.

FIG. 6 again shows a grid that has been displaced from the roof section 6 via a pushing movement to the front toward the operator's cabin and can be folded in front of the front side of the operator's cabin 2 by a downward folding with respect to a rotary axle that extends in the width direction of the operator's cabin 2 and that is arranged in the upper region or above the operator's cabin 2. For the front grid, this is the transition from the front visibility mode toward the protective position. If, however, the grid shown in FIG. 6 is the roof grid, it is the transition from the protective position toward a transport mode.

The movement of the two grids 4, 5 is identical in each of the FIGS. 5 and 6 so that only one grid has been shown for reasons of better clarity. However, the invention also covers the case that the operator's cabin only has one of the two grids.

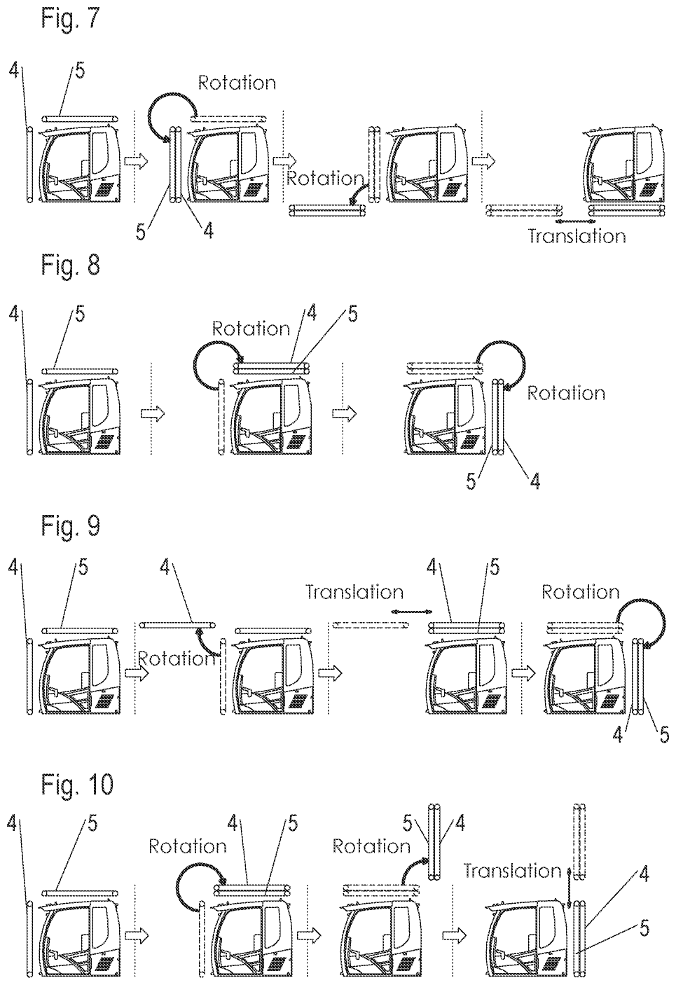

FIG. 7 shows a further embodiment of the present invention using which, in a first step, now the roof grid 5 no longer remains in its protective position, but the roof grid 5 is rather pivoted in front of the front grid 4 via a pivot axle extending in the width direction of the operator's cabin. If the pivoting has taken place, a pivoting of the two grids 4, 5, that are now aligned in parallel with one another, can take place via a further rotary axle that likewise extends in the width direction of the operator's cabin 2 and is arranged in the lower region of the operator's cabin or below the operator's cabin so that the two grids arranged in parallel fold down away to the front and are preferably aligned horizontally. If they are in a state folded away down to the front, the two grids can be pushed into a reception space arranged beneath the operator's cabin. The kinematics of the two grid movements can, for example, take place by a first hinge connection of the roof grid and front grid 4 so that the roof grid 5 can be pivoted to the front side of the front grid 4. The front grid itself then has a pivot connection to the operator's cabin in the lower region so that the two grids 4, 5 aligned in parallel with one another can be pivoted away downward to the front together. The two grids can then be pushed via rails or a different sliding system into the reception space arranged beneath the operator's cabin.

FIG. 8 shows a further embodiment of the present invention in which the front grid 4 is again pivoted onto the upper side of the roof grid 5 via a rotary axle extending in the width direction of the operator's cabin 2. A further rotation of the two grids 4, 5 aligned in parallel by approximately 270° produces a lying alongside of the two grids at the rear side of the operator's cabin 2. The rotary axles can be executed, for example, by a hinge connection between the roof grid 5 and the front grid 4 and by a hinge connection between the roof grid 5 and the operator's cabin. It is also clear to the skilled person that fastening means can preferably be provided for a common pivoting of the two grids 4, 5, aligned in parallel with one another to prevent an uncontrolled pivoting of the front grid 4 away from the roof grid 5 on the placing onto the rear side of the operator's cabin 2.

FIG. 9 shows a further embodiment of the present invention, in which the front grid cannot, for instance, be placed onto the upper side of the roof grid 5 by a pivot movement by 270°, but is rather only folded away upward to the front by 90° in a first step. The rotary axle is here located in a front upper section of the operator's cabin 2 or is located above the operator's cabin 2 in the front region. If the front grid 4 is now aligned horizontally in a first step, a stacking of the front gird 4 on the roof grid 5 can take place via a one-dimensional translatory movement. The subsequent pivoting about of the two grids 4, 5 stacked on top of one another toward a rear side of the operator's cabin 2 then again takes place via a pivot connection of the roof grid 5 with the operator's cabin 2.

FIG. 10 shows a further embodiment of the present invention in which the front grid 4 is again pivoted onto the upper side of the roof grid 5 by 270° about a rotation via a rotary axle extending along a width direction of the operator's cabin 2. Differing from FIG. 9, no rotation of the two grids stacked on top of one another by 270° now takes place, but rather only by 90° so that the two grids aligned in parallel with one another can be pushed into a rear reception section at the rear side of the operator's cabin 2 by a subsequent one-dimensional translatory movement (that is directed approximately perpendicular downward).

FIG. 11 shows a further embodiment of the present invention, in which the two grids 4, 5 are not stored in a common reception space or in a parallel alignment with one another. The front grid 4 and the roof grid 5 can be seen in their respective protective positions on the left side of FIG. 11. Each grid is here pivoted away from its protective position via a rotary axle extending in parallel with the width direction of the drive cabin. The rotary axle of the front grid 4 here extends at the lower region or beneath the operator's cabin, with the rotary axle of the roof grid 5 extending at the rear upper region or above the operator's cabin. Each of the grids is here pivoted about 90° from its protective position and is traveled in a subsequent step below or behind the operator's cabin. The separate pivoting away of the respective grids from their protective positions is accordingly possible here without restrictions for the other grid being present.

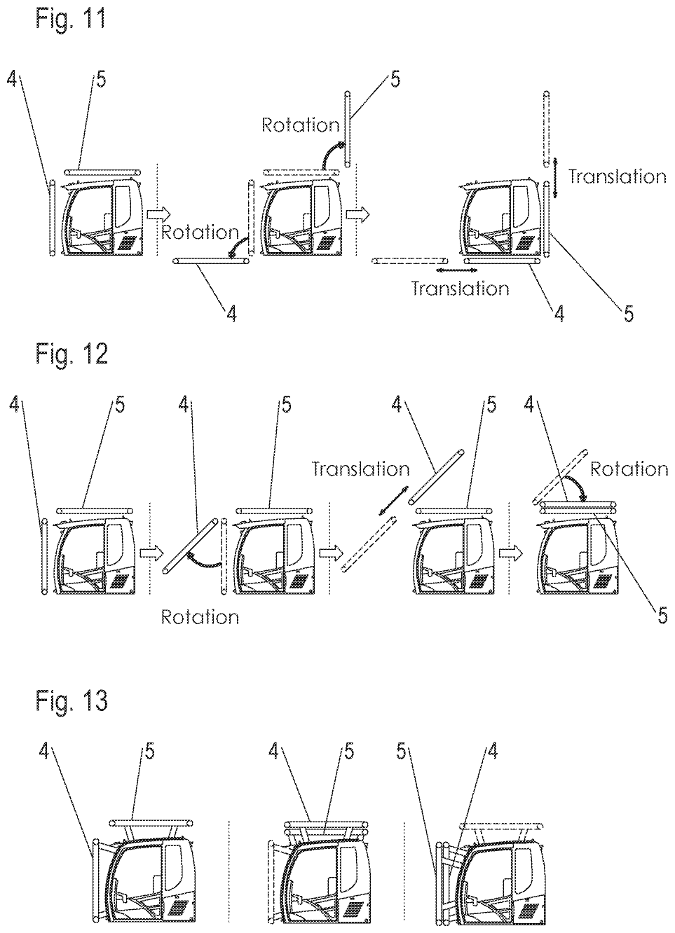

FIG. 12 shows a further embodiment for moving the front grid 4 onto the upper side of the roof grid 5. In this respect, the front grid is pivoted about approximately 45° about a rotary axle extending in the upper region of the operator's cabin transversely to the operator's cabin, is then pushed upwardly away such that the front grid 4 is arranged remote from the roof grid 5, and is rotated downward by 45° so that is lies on the upper side of the roof grid 5. It is clear to the skilled person that the value of 45° is only of an exemplary nature and other angular values can also be used for a corresponding use of the idea. Only the folding movement, the subsequent one-dimensional displacement, and the subsequent folding down of the front grid are decisive in the present case.

FIG. 13 shows a further embodiment of the present invention in which each of the two grids 4, 5 is connected to the operator's cabin via a rail system. The rail system here extends from the roof section 6 and extends up to the front section of the operator's cabin 2. On the movement of a grid from its protective position, a curved movement along a slide or along the rails is made in two directions in this process. Provision can be made here that both the front grid 4 and the roof grid 5 comprise a separate rail pair or a separate rail for moving the associated grid.

1. An operator's cabin (1) for a work machine, in particular an earth-moving machine, comprising:
a housing structure (2) that surrounds a workplace for an operator;
a front grid (4) that is positioned in its protective position in front of a front side (3) of the operator's cabin (1); and
a roof grid (5) that can optionally be provided and that is positioned in its protective position above a rood section (6) of the operator's cabin (1),
wherein
the front grid (4) and/or the roof grid (5) can be moved out of their respective protective positions by a rotary movement and/or translatory movement and in so doing nevertheless remains/remain connected to the operator's cabin (1).

2. An operator's cabin in accordance with claim 1, wherein the front grid (4) and the roof grid (5) each have a shape that enables a nesting that is as compact as possible, with it preferably having a substantially similar structural side contour that enables a stacking of the two grids (4, 5) on top of one another.

3. An operator's cabin (1) in accordance with claim 1, wherein
the front grid (4) and the roof grid (5) are pivotable out of their respective protective positions via a common rotary axle (7) such that the grid (4, 5) pivoted out of its protective position lies alongside the grid (4, 5) remaining in its protective position at its side remote from the operator's cabin (1).

4. An operator's cabin (1) in accordance with claim 1, wherein the front grid (4) can be moved by rotation about a rotary axle extending in the width direction (X) of the operator's cabin (1) and by a translatory movement into a position in which the front grid (4) is laid alongside the roof grid (5) located in its protective position at its side remote from the operator's cabin (1), with the front grid (4) located in its protective position first undergoing a translatory movement and subsequently lying alongside a side of the roof grid (5) remote from the operator's cabin (5) by a rotary movement or the front grid (4) located in its protective position first undergoing a rotary movement and subsequently lying alongside the side of the roof grid (5) remote from the operator's cabin (1) by a translatory movement.

5. An operator's cabin (1) in accordance with claim 1, wherein the front grid (4) moved out of its protective position and arranged at the side of the roof grid (5) arranged at the roof section (6) remote from the operator's cabin (1), is movable together with the roof grid (5) by a common rotary movement and/or a common translatory movement away from the roof section (6) toward a rear, left or right side of the operator's cabin (1).

6. An operator's cabin (1) in accordance with claim 5, wherein the roof grid (5) located in its protective position is movable together with the front grid (4) arranged thereabove via a rotary axle extending in parallel with the longitudinal direction of the operator's cabin (1) to the left or right side of the operator's cabin (1), with the grids preferably being rotated here by approximately 250° to 280°, more preferably 260° to 270°, from the protective position of the roof grid (5) about the rotary axle extending in parallel with the longitudinal direction of the operator's cabin (1).

7. An operator's cabin (1) in accordance with claim 5, wherein the roof grid (5) located in its protected position can be moved together with the front grid (4) arranged thereabove by a common rotation about a rotary axle extending in the width direction (X) of the operator's cabin (1) and by a translatory movement into a position in which the two grids are arranged behind the operator's cabin (1), with the two grids arranged above the roof section (6) preferably first undergoing a translatory movement and subsequently lying alongside the rear side of the operator's cabin (1) oppositely disposed the front side by a rotary movement or the two grids arranged above the roof section (6) first undergoing a rotary movement and subsequently lying alongside the rear side of the operator's cabin (1) oppositely disposed the front side by a translatory movement.

8. An operator's cabin (1) in accordance with claim 5, wherein the roof grid (5) located in its protective position can be conveyed together with the front grid (4) arranged thereabove by a common parallelogram deflection into a region arranged behind the operator's cabin (1).

9. An operator's cabin (1) in accordance with claim 1, wherein the roof grid (5) can be moved by rotation about a rotary axle extending in the width direction of the operator's cabin (1) and by a translatory movement into a position in which the roof grid (5) is laid alongside the front grid (4) located in its protective position at its side remote from the operator's cabin (1), with the roof grid (5) located in its protective position first undergoing a translatory movement and subsequently lying alongside a side of the front grid (4) remote from the operator's cabin (1) by a rotary movement or the roof grid (5) located in its protective position first undergoing a rotary movement and subsequently lying alongside the side of the front grid (4) remote from the operator's cabin (1) by a translatory movement.

10. An operator's cabin (1) in accordance with claim 1, wherein the roof grid (5) moved out of its protective position and arranged at the side of the front grid (4) arranged at the front side remote from the operator's cabin (1), is movable together with the front grid (4) away from the front side below the operator's cabin (1) by a common rotary movement and/or a common translatory movement.

11. An operator's cabin (1) in accordance with claim 10, wherein the front grid (4) located in its protective position together with the roof grid (5) arranged in front of it can be brought by a common rotation about a rotary axle extending in the width direction of the operator's cabin (1) and by a translatory movement into a position in which the two grids are arranged below the operator's cabin (1), in particular directly below the operator's cabin (1), with the two grids arranged in front of the front side preferably first undergoing a rotary movement and subsequently being able to be pushed below the operator's cabin (1) by a translatory movement.

12. An operator's cabin (1) in accordance with claim 11, wherein the front grid (4) located in its protective position can be moved together with the roof grid (5) arranged in front of it by a common rotation about a rotary axle extending in the width direction of the operator's cabin (1) into an approximately horizontal alignment and can subsequently be pushed into a cutout arranged beneath the operator's cabin (1).

13. An operator's cabin (1) in accordance with claim 1, wherein
the front grid (4) located in its protective position can be folded away downwardly from the front side of the operator's cabin (1) via a first rotary axle so that it can be pushed into a reception space arranged below the operator's cabin (1) via a subsequent one-dimensional translatory movement; and/or
the roof grid (5) located in its protective position can be folded away to the rear from the roof section (6) via a second rotary axle so that it can be introduced into a reception space arranged behind the operator's cabin (1) via a subsequent one-dimensional translatory movement, with the rotation of a respective grid about its rotary axle preferably adopting a range from 70° to 110°, more preferentially 80° to 100°.

14. An operator's cabin (1) in accordance with claim 1, wherein the movement of the front grid (4) and/or of the roof grid (5) takes place by a drive that can be actuated from the operator's cabin (1), with the drive preferably being a hydraulic and/or an electric motor drive and being usable for moving the roof grid and/or front grid (4).

15. A work machine, in particular an earth-moving machine, having an operator's cabin (1) in accordance with claim 1.

16. An operator's cabin (1) in accordance with claim 2, wherein
the front grid (4) and the roof grid (5) are pivotable out of their respective protective positions via a common rotary axle (7) such that the grid (4, 5) pivoted out of its protective position lies alongside the grid (4, 5) remaining in its protective position at its side remote from the operator's cabin (1).

17. An operator's cabin (1) in accordance with claim 16, wherein the front grid (4) can be moved by rotation about a rotary axle extending in the width direction (X) of the operator's cabin (1) and by a translatory movement into a position in which the front grid (4) is laid alongside the roof grid (5) located in its protective position at its side remote from the operator's cabin (1), with the front grid (4) located in its protective position first undergoing a translatory movement and subsequently lying alongside a side of the roof grid (5) remote from the operator's cabin (5) by a rotary movement or the front grid (4) located in its protective position first undergoing a rotary movement and subsequently lying alongside the side of the roof grid (5) remote from the operator's cabin (1) by a translatory movement.

18. An operator's cabin (1) in accordance with claim 3, wherein the front grid (4) can be moved by rotation about a rotary axle extending in the width direction (X) of the operator's cabin (1) and by a translatory movement into a position in which the front grid (4) is laid alongside the roof grid (5) located in its protective position at its side remote from the operator's cabin (1), with the front grid (4) located in its protective position first undergoing a translatory movement and subsequently lying alongside a side of the roof grid (5) remote from the operator's cabin (5) by a rotary movement or the front grid (4) located in its protective position first undergoing a rotary movement and subsequently lying alongside the side of the roof grid (5) remote from the operator's cabin (1) by a translatory movement.

19. An operator's cabin (1) in accordance with claim 2, wherein the front grid (4) can be moved by rotation about a rotary axle extending in the width direction (X) of the operator's cabin (1) and by a translatory movement into a position in which the front grid (4) is laid alongside the roof grid (5) located in its protective position at its side remote from the operator's cabin (1), with the front grid (4) located in its protective position first undergoing a translatory movement and subsequently lying alongside a side of the roof grid (5) remote from the operator's cabin (5) by a rotary movement or the front grid (4) located in its protective position first undergoing a rotary movement and subsequently lying alongside the side of the roof grid (5) remote from the operator's cabin (1) by a translatory movement.

20. An operator's cabin (1) in accordance with claim 17, wherein the front grid (4) moved out of its protective position and arranged at the side of the roof grid (5) arranged at the roof section (6) remote from the operator's cabin (1), is movable together with the roof grid (5) by a common rotary movement and/or a common translatory movement away from the roof section (6) toward a rear, left or right side of the operator's cabin (1).
